(19) United States
(12) Patent Application Publication
(10) Pub. No.: US 2009/0272412 A1
(43) Pub. Date: Nov. 5, 2009

(54) High-Pressure Cleaner Having An Integrated Textile Flat Hose

(76) Inventors: Jurgen Steinhauser, Stuttgart (DE); Volker Reber, Michelbach an der Bilz (DE)

Correspondence Address: ROBERT W. BECKER & ASSOCIATES, 707 HIGHWAY 333, SUITE B, TIJERAS, NM, 87059-7507, US

(21) Appl. No.: 12/430,676

(22) Filed: Apr. 27, 2009

(30) Foreign Application Priority Data
May 3, 2008 (DE) 10 2008 022 047.7

(51) Int. Cl. B08B 3/00

(52) U.S. Cl. 134/198

(57) ABSTRACT

A high-pressure cleaner having a housing and a high-pressure hose for connection to a spray fixture. The high-pressure cleaner includes a textile flat hose for connection to a water supply.

The instant application should be granted the priority date of May 3, 2008 the filing date of the corresponding German patent application 10 2008 022 047.7.

### BACKGROUND OF THE INVENTION

The present invention relates to high-pressure cleaning apparatus or cleaner.

DE 202 13 001 U1 discloses a high-pressure cleaning apparatus that has a high-pressure hose and a connector for a liquid supply line. The liquid supply line is embodied as a separate hose line.

It is an object of the present invention to provide a high-pressure cleaner of the aforementioned general type that has a straightforward and compact construction.

### BRIEF DESCRIPTION OF THE DRAWINGS

This object, and other objects and advantages of the present invention, will appear more clearly from the following specification in conjunction with the accompanying schematic drawings, in which:

FIG. 1 is a perspective illustration of a first exemplary embodiment of a high-pressure cleaner,

FIG. 2 is a perspective illustration of an embodiment of the high-pressure cleaner of FIG. 1,

FIGS. 3 & 4 are further embodiments of the high-pressure cleaner of FIG. 1,

FIG. 5 shows the hose reel of the high-pressure cleaner of FIGS. 3 and 4 in the operating position,

FIG. 6 is a perspective illustration of an embodiment of the high-pressure cleaner of FIG. 1,

FIGS. 7 & 8 are partial perspective illustrations of the hose reel of the high-pressure cleaner of FIG. 6 in different positions,

FIG. 9 is a perspective illustration of an embodiment of the high-pressure cleaner of FIG. 1,

FIGS. 10 & 11 are perspective, partial illustrations of the hose reel of the high-pressure cleaner of FIG. 9 in different positions,

FIG. 12 is a perspective illustration of the high-pressure cleaner of FIG. 1,

FIGS. 13 & 14 are perspective illustrations of the hose reel of the high-pressure cleaner of FIG. 12 in different states,

FIG. 15 is a perspective illustration of an embodiment of the high-pressure cleaner of FIG. 1,

FIG. 16 is a perspective illustration of the hose reel of the high-pressure cleaner of FIG. 15 in the operating position,

FIG. 17 is a perspective illustration of an embodiment of a hose reel,

FIGS. 18 & 19 are schematic cross-sectional illustrations of an embodiment of a hose reel,

FIGS. 20-22 are schematic side views of embodiments of hose reels,

FIGS. 23 & 24 are schematic side views of folding devices for the textile flat hose,

FIG. 25 is a perspective exploded view of an embodiment of a hose reel,

FIG. 26 is a schematic perspective illustration of an embodiment of a flat hose,

FIG. 27 is a schematic side view of an embodiment of the high-pressure cleaner,

FIG. 28 is a schematic cross-sectional illustration through the hose reel of the high-pressure cleaner of FIG. 27 taken along the line XXVIII-XXVIII with the hose reel pivoted,

FIG. 29 is a cross-sectional view through the hose reel taken along the line XXIX-XXIX in FIG. 28,

FIG. 30 is a schematic cross-sectional view through the pivot support of the hose reel taken along the line XXX-XXX in FIG. 29,

FIG. 31 is a schematic cross-sectional view through an embodiment of a pivot support of a hose reel, and

FIG. 32 is a schematic cross-sectional view of the pivot support of FIG. 31 in a different position of the reel.

### SUMMARY OF THE INVENTION

The object of the invention is realized by a high-pressure cleaner that comprises a housing; a high-pressure hose carried by the housing and adapted to be connected to a spray fixture; and a textile flat hose adapted to be carried by the housing and further adapted to be connected to a water supply.

Due to the fact that the connecting line for connection to a water supply is provided at the high-pressure cleaner itself, no separate connecting line is required. By embodying the connecting line as a textile flat hose, it is possible to achieve a compact construction. The installation space required for the connecting line is small. Due to the flexibility of the textile flat hose, the hose acts as a pressure buffer or absorber, so that pressure surges from the water line when shutting off are reduced. At the same time, the textile flat hose forms a water volume reservoir for areas having a fluctuating water supply. This is possible due to the fact that the textile flat hose is limp to bending. This prevents the formation of an underpressure in the hose, which could lead to changing over of the pump into suction operation.

The high-pressure cleaner advantageously includes a stowing device for the textile flat hose that is in particular integrated into the housing of the high pressure cleaner. As a result, a separate connecting hose can be eliminated. All components that are required for operating the high-pressure cleaner can be integrated on the high-pressure cleaner. The stowing device is advantageously adjustable on the housing between a stowed position and an operating position in which the textile flat hose can be removed or disposed on the stowing device. Due to the fact that a stowed position and an operating position are provided, the textile flat hose can be disposed so as to be easily accessible in the operating position. In the stowed position, the textile flat hose is advantageously disposed in such a way that it does not obstruct the operator during transport of the high-pressure cleaner, and that a closed exterior of the housing of the high-pressure cleaner results. In the stowed position, the stowing device is advantageously disposed in a recess or receiving means on the housing, whereby the stowing device is advantageously disposed entirely in the housing and in this position does not extend beyond the outer surface of the housing.

The stowing device advantageously includes a winding device for the textile flat hose. The winding device in particular has a hose reel for the textile flat hose. In this connection, the hose reel is rotatably mounted, thus enabling a simple winding and unwinding of the textile flat hose. The term hose reel as used in the context of the present application is to be understood broadly, and includes, by way of example only, drums, reels, individual rods or supports, or other elements about which the textile flat hose can be wound.

The hose reel is advantageously adjustable between a winding state and a stowed state, whereby in the stowed state the width of the hose reel, which is measured perpendicular to the axis of rotation, is less than the height of the hose reel, also measured perpendicular to the axis of rotation. In the emptied or drained state, the textile flat hose is very flexible. As a result, the hose reel, together with the flat hose wound thereon, can be adjusted out of the wound state into a stowed state, for example by being folded together. Consequently, the hose reel can easily be integrated into the available installation space in the housing of the high-pressure cleaner. The installation space required for stowing the hose reel is small.

The high-pressure hose and the textile flat hose are advantageously each wound onto a respective hose reel, whereby both of the hose reels are rotatable about a common axis. This results in a straightforward construction. The two hose reels can be connected to one another, so that the two hoses are always wound up or unwound together. However, separate hose reels can also be provided. The hose reels can, for example, be disposed in the region of a handle or the like provided for guiding the high-pressure cleaner. The hose reel is advantageously provided with operating or control means for turning the hose reel. To enable a rapid winding of the textile flat hose, the winding device is provided with a support or holder for the central portion of the textile flat hose. Due to the fact that the central portion of the textile flat hose is held or supported on the winding device, the textile flat hose is wound up in a double layer. This prevents at the same time a twisting of the textile flat hose.

An automatic winding device is advantageously provided for the textile flat hose. The winding device advantageously includes a return spring, which during unwinding of the textile flat hose is tensioned. The winding of the textile flat hose can thus be effected in a simple manner by releasing an arresting means or the like.

The stowing device expediently includes at least one holder, which is secured to the housing and about which the textile flat hose can be wound. This results in a simple construction of the stowing device. It can also be advantageous for the stowing device to include a folding device for the textile flat hose. During the folding together of the textile flat hose, a twisting of the hose is prevented. The folding device for the textile flat hose advantageously includes at least two rows of deflection stubs, which are offset relative to one another and the spacing of which is variable. The folding device for the textile flat hose in particular includes two components that extend into one another in a comb-like manner and between which the textile flat hose is folded.

To simplify putting the high-pressure cleaner into operation, the high-pressure cleaner includes a connector for the textile flat hose, wherein the hose, which is disposed in the stowing device, can be connected to the connector. As a result, even in the stowed state the textile flat hose can already be connected. To put the high-pressure cleaner into operation, it is merely necessary to remove the textile flat hose from the stowing device, for example by unwinding it therefrom, and to connect it to a water supply.

To ensure a small installation space of the flat hose in the wound-up state, an emptying or draining device is provided for the textile flat hose for at least partially squeezing or stripping out any residual liquid contained in the textile flat hose during winding up of the hose. A straightforward configuration results if the draining device is provided with a slot through which the textile flat hose is guided. To prevent the formation of kinks in the textile flat hose during operation, the hose advantageously has an inner structure that in the non-loaded state presses the textile flat hose open.

Further specific features and advantages of the present application will be described in detail subsequently.

### DESCRIPTION OF SPECIFIC EMBODIMENTS

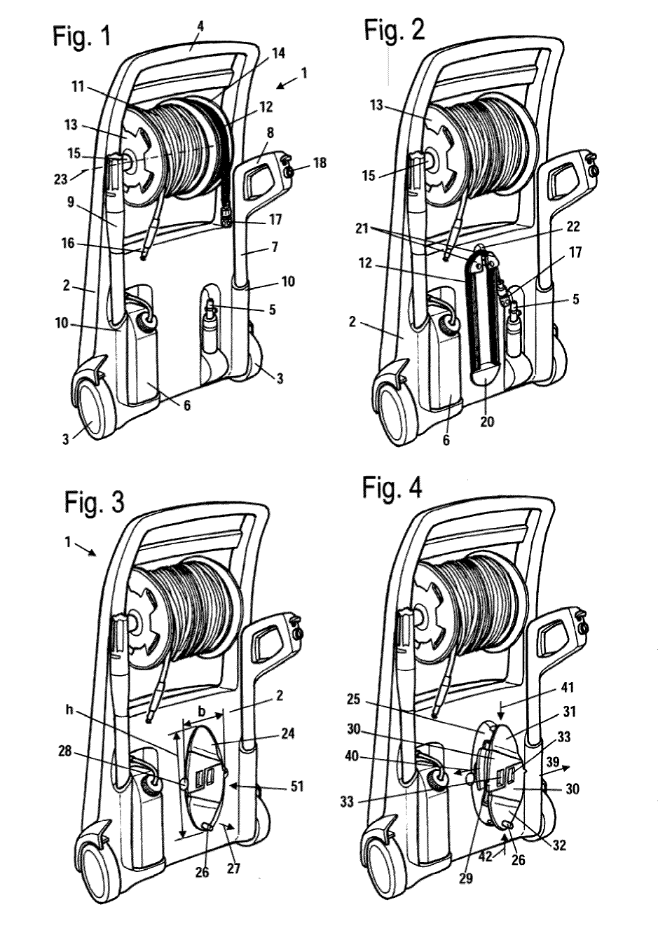

Referring now to the drawings in detail, the high-pressure cleaning apparatus or cleaner 1 illustrated in FIG. 1 has a housing 2, in which is disposed a non-illustrated high-pressure pump. The high-pressure cleaner 1 has two wheels 3, by means of which the cleaner 1 can be pulled over the ground. Formed on the housing 2 is a handle 4, via which the operator can pull the high-pressure cleaner 1 over the ground. The cleaner 1 has a connector 5 for connection to a textile flat hose 12. The flat hose 12 is wound onto a hose reel 14, which is mounted on a support or pivot shaft 15 so as to be rotatable about an axis of rotation 23. The hose reel 14 is disposed in the vicinity of the handle 4. Next to the hose reel 14, a hose reel 13 for a high-pressure hose 11 is mounted on the pivot shaft 15. The two hose reels 13 and 14 can be connected to one another; however, the two hose reels 13, 14 are advantageously rotatable about the axis of rotation 23 independently of one another.

The high-pressure hose 11 has a connection coupling 16 for a connection to a spray fixture, such as a spray lance 7 or a spray nozzle 9. Other spray fixtures can also be advantageous. The spray lance 7 has a grip 8, in the vicinity of which is provided a connection opening 18 for the connection coupling 16 of the high-pressure hose 11. The spray lance 7 and the spray nozzle 9 are respectively removably held in a receptacle or holder 10 on the housing 2. The textile flat hose 12 has a connection coupling 17 for connection to the connector 5. The other end of the textile flat hose 12 is intended for connection to a water supply, for example to a water faucet. By means of the textile flat hose 12, water is drawn in by the high-pressure pump disposed in the housing 2 and is conveyed under high pressure into the high-pressure hose 11. From the high-pressure hose 11, the water can be discharged via a spray fixture, such as the spray lance 7 or the spray nozzle 9, for cleaning surfaces that are to be processed. It is also possible that the surface that is to be processed is not to be processed with water, but rather with a cleaning agent. For cleaning agent, the spraying agent container 6 shown in FIG. 1 is disposed on the housing 2.

Due to the fact that not only the high-pressure hose 11 but also the textile flat hose 12 are held on the housing 2 of the high-pressure cleaner 1, no additional connection hose is required for the connection to the water supply. All of the connection hoses that are needed are integrated on the high-pressure cleaner 1.

With the embodiment of the high-pressure cleaner 1 shown in FIG. 2, the textile flat hose 12 is not wound on a hose reel, but rather on holders 20 and 21. These holders 20, 21 are disposed on the housing 2 adjacent to the connector 5 and to the spraying agent container 6. The holder 21 that is adjacent to the hose reel 13 for the high-pressure hose 11 has a two-part configuration. In the vicinity of the second holder 21 a receiving means 22 is provided in the housing 2 through which a second connection coupling of the textile flat hose 12 can be inserted for the fixation.

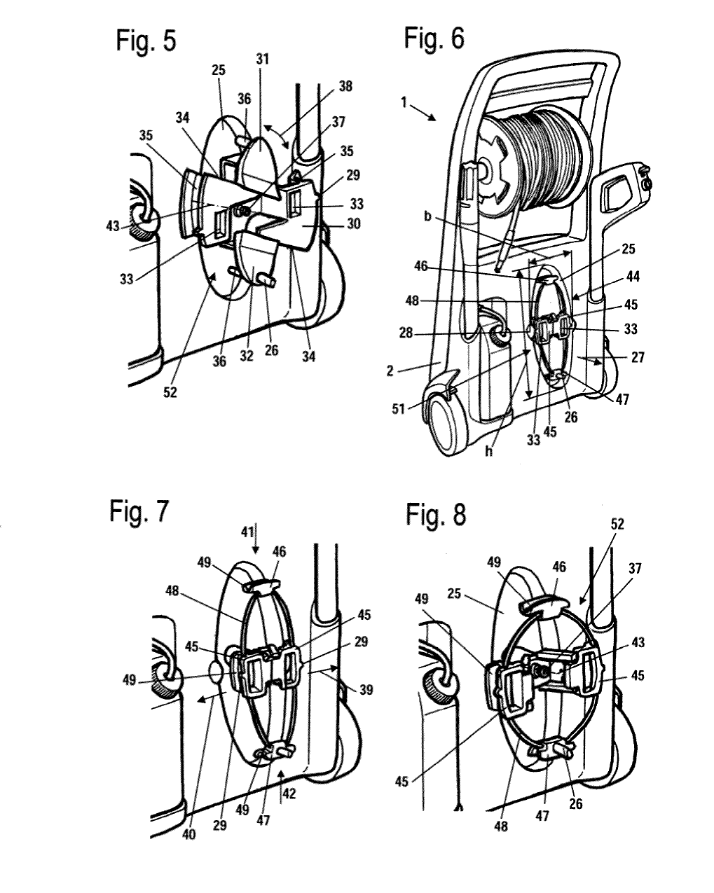

The embodiment of the high-pressure cleaner 1 shown in FIGS. 3 to 5 has a hose reel 24, which in the stowed position 51 shown in FIG. 3 is integrated in the housing 2. The hose reel 24 is held in the housing 2 by a fixation means 28. In the stowed position 51, the width b of the hose reel 24, as measured perpendicular to the axis of rotation 43 of the hose reel 24 (FIG. 5), is considerably less than the height h of the hose reel 24, which is also measured perpendicular to the axis of rotation 43. In this connection, the width b is advantageously disposed approximately horizontally, and the height h is disposed approximately vertically; however, other orientations of the hose reel 24 can also be advantageous. The width b designates the smallest extension of the hose reel 24, as measured perpendicular to the axis of rotation 43, and the height h designates the largest extension, measured perpendicular to the axis of rotation 43. In the stowed position 51, the hose reel 24 is oval. Provided on the hose reel 24 is a control pin 26, at which the hose reel 24 can be withdrawn from the housing 2 in the direction of the arrow 27, in other words, approximately in the direction of the axis of rotation 43 shown in FIG. 5.

As shown in FIG. 4, the hose reel 24 is disposed in the housing 2 in a recess or a receiving means 25. In the position shown in FIG. 4, the hose reel 24 is disposed in front and externally of the recess 25. The hose reel 24 has four portions, namely two side portions 30, an upper portion 31, and a lower portion 32. Upwardly extending projections 29 are formed on the side portions 30, whereby one of the projections cooperates with the fixation means 28 shown in FIG. 3, so that in the stowed position 51, the hose reel 24 is reliably held in the housing 2.

In order to bring the hose reel 24 into the operating position 52 shown in FIG. 5, the side portions 30 can be pulled outwardly in the direction of the arrows 39 and 40. The upper portion 31 is pushed downwardly in the direction of the arrow 41, and the lower portion 32 is pushed upwardly in the direction of the arrow 42. The movement of the upper portion 31 and of the lower portion 32 is advantageously coupled to the movement of the two side portions 30, thus resulting in a positive guidance. Each of the side portions 30 has a recessed area 33 in which the operator can grip the side portions 30 and pull them out. As the side portions 30 are pulled outwardly, the upper portion 31 and the lower portion 32 are guided along guide edges 34 of the side portions 30.

In the operating position 52 shown in FIG. 5, winding channels 35, which are formed on the outer periphery of the side portions 30, together with pins or support elements 36 formed on the upper portion 31 and on the lower portion 32, form support surfaces for the textile flat hose 12 that are disposed along a circle about the axis of rotation 43. In the operating position 52, by turning the hose reel 24 about the axis of rotation 43, the textile flat hose 12 can be wound onto or unwound from the hose reel 24. Provided in the region of the axis of rotation 43 is a connection 37 for the textile flat hose 12 at which the hose can be connected to the high-pressure cleaner 1. In order to be able to stow the textile flat hose in the housing 2, in the operating position 52 of the hose reel 24 the textile flat hose 12 is wound onto the hose reel 24 after the hose is separated from the connection 37. Subsequently, the side portions 40 are pulled inwardly and the upper and lower portions 31 and 32 are pulled outwardly, so that the hose reel 24 achieves the oval shape shown in FIG. 4. The hose reel 24 is subsequently pressed into the housing 2, counter to the arrow 27 shown in FIG. 3, until the projection 29 catches behind the fixation means 28. To wind the textile flat hose 12 up or to unwind it, the hose reel 24 is rotated about the axis of rotation 43 in the direction of the double arrow 38 (FIG. 5).

FIG. 6 to 8 show an embodiment of a hose reel 44, which is also integrated in the housing 2. In the stowed position 51 shown in FIG. 6, the hose reel 44 has a width b, which is significantly less than the height h of the hose reel 44. In this connection, the width b and the height h are measured perpendicular to the axis of rotation 43 shown in FIG. 8. In the stowed position 51 shown in FIG. 6, the hose reel 44 is disposed in a recess or receiving means 25 in the housing 2, and is held in the housing 2 at a projection 29 by a fixation means 28. The hose reel 44 has two side portions 45, an upper portion 46, and a lower portion 47. The side portions 45 are provided with recessed areas 33 for their actuation. Disposed at the lower portion 47 is a control pin 26, by means of which the hose reel 44 can be pulled out of the housing 2 in the direction of the arrow 27.

FIG. 7 shows the hose reel 44 in the state where it is pulled out of the housing 2. As can be seen, formed on the outer side of each of the portions 45, 46 and 47 is a winding channel 49 in which the textile flat hose 12 can be wound. The portions 45, 46 and 47 are interconnected by an elastic strap or band 48 that couples the movement of the upper and lower portions 46 and 47 to the movement of the side portions 45. In order to bring the hose reel 44 into the operating position shown in FIG. 8, the side portions 45 must be pulled out in the direction of the arrows 39 and 40. As a result of the band 48, the upper portion 46 and the lower portion 47 are pulled inwardly toward the axis of rotation 43. In the operating position 52 shown in FIG. 8, the winding channels 49 on the portions 45, 46 and 47 form an approximately circular shape. In the operating position 52 shown in FIG. 8, the textile flat hose 12 can be wound onto or unwound from the hose reel 44.

To be able to stow the textile flat hose 12 in the housing 2, the hose is first wound onto the hose reel 44 in the operating position 52. Prior to the winding, the textile flat hose 12 is separated from the connection 37. The side portions 45 are subsequently pressed inwardly in the direction toward the axis of rotation 43. As a result, the upper portion 46 and the lower portion 47 are pressed outwardly, thus resulting in the approximately elliptical shape of the hose reel 44 shown in FIG. 7. The hose reel 44 is subsequently pressed into the recess 25 counter to the arrow 27 shown in FIG. 6.

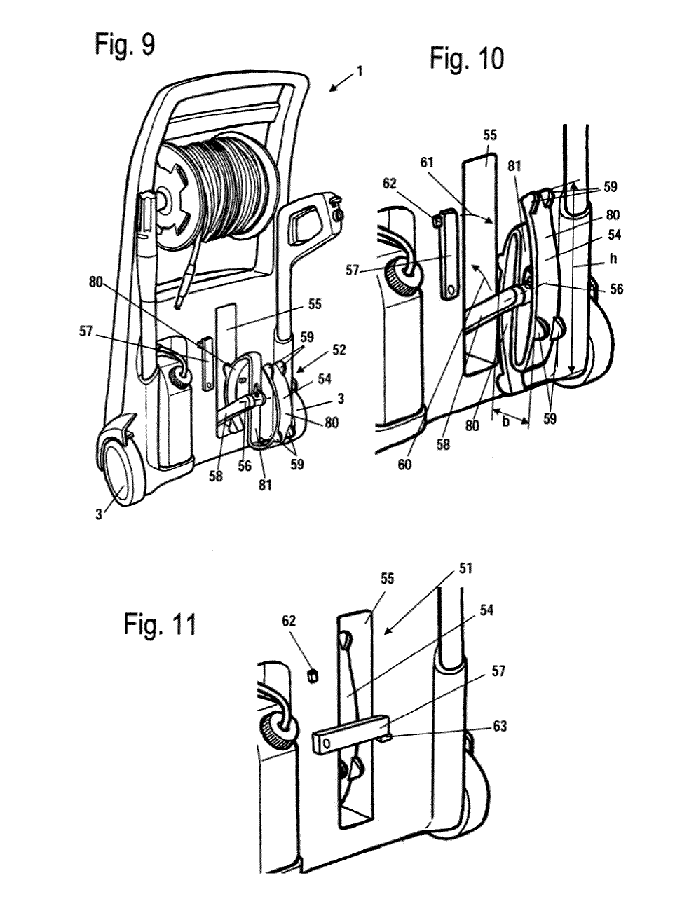

FIGS. 9 to 11 show a further embodiment of the hose reel 54, which is comprised of an approximately S-shaped holder of elastic material. In FIG. 9, the hose reel 54 is shown in the operating position 52. The two curved or arched portions 80 of the S-shaped hose reel 54 serve for the winding up of the textile flat hose 12. Provided in these regions are lateral guides 59 in order to be able to laterally guide the textile flat hose 12 at the outer side of the hose reel 54. The central portion 81 of the hose reel 54 is mounted on a pivotable arm 58 so as to be rotatable about an axis of rotation 56, which extends parallel to the outer side of the housing 2 and parallel to the axes of rotation of the wheels 3 of the high-pressure cleaner 1.

To dispose the hose reel 54 in the housing 2, the hose reel 54 is first pressed together until the two arched portions 80 are disposed next to one another and extend nearly parallel to the central portion 81; this is shown in FIG. 10. The hose reel 54 is disposed adjacent to a recess or receiving means 55 in the housing 2. Pivotably mounted on the outer side of the housing 2 is a latch or locking lever 57, which in the positions shown in FIGS. 9 and 10 rests against a stop or abutment 62. As shown in FIG. 10, in the folded together state, the width b of the hose reel 54 is significantly less than the height h. In this connection, the width b and the height h are measured perpendicular to the axis of rotation 56. After the folding together, the hose reel 54 is pivoted in the direction of the arrow 60 into the recess 55. Subsequently, the latch 57 is pivoted in the direction of the arrow 61 until it comes to rest against a stop or abutment 63 and the hose reel 54 is secured in the recess 55. In FIGS. 9 to 11, the hose reel 54 is shown without the textile flat hose 12. To stow the textile flat hose 12, the hose is first wound onto the hose reel 54 in the operating position 52 shown in FIG. 9; the hose reel 54 is subsequently folded and pivoted into the housing 2. In FIG. 11, the hose reel 54 is shown in its stowed position 51.

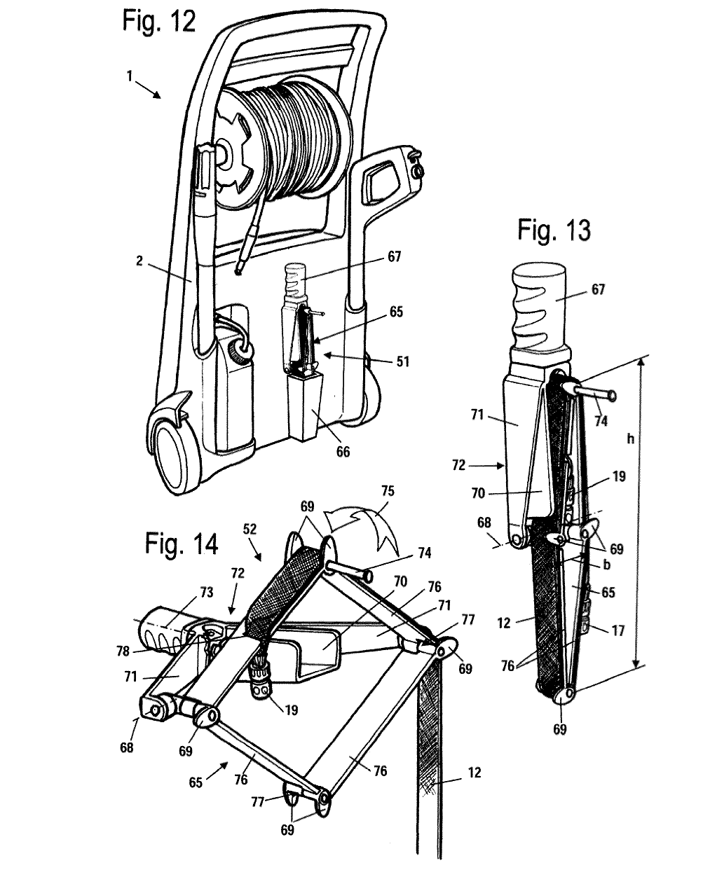

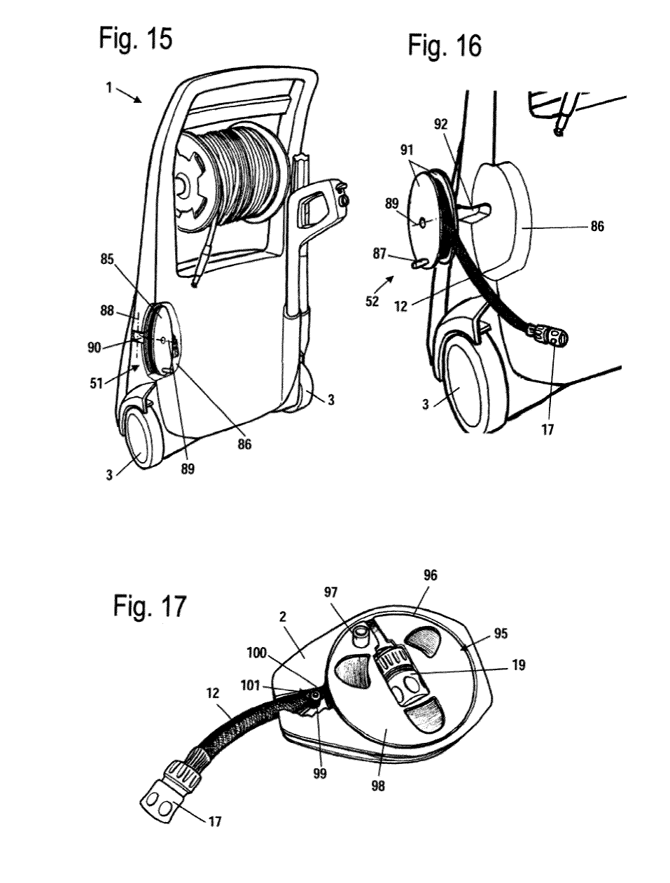

FIGS. 12 to 14 show a high-pressure cleaner 1 having a hose reel 65, which is disposed in a receptacle or holder 66 on the housing 2. The hose reel 65 has a handle 67 by means of which the hose reel can be removed from the receiving means or holder 66. The hose reel 65 is disposed in a stowed position 51 in the holder 66. As shown in FIG. 15, the width b of the hose reel 65 in this position is significantly less than the height h of the hose reel 65. Provided on the handle 67 is a holding support 72, which includes two side arms 71 as well as the receiver 70 shown in FIG. 14. In the stowed position 51, the flat hose 12 is partially disposed in the receiver 70. As shown in FIG. 13, the flat hose 12 has a second connection coupling 19 for connection to the connector 5 of the housing 2. This connector not being shown in FIG. 12.

As shown in FIG. 14, the hose reel 65 includes four side plates 76, which are connected to one another via hinges 77. Respective lateral guides 69 for the textile flat hose 12 are provided in the region of each of the hinges 77. One of these side plates 76 has a slot 78 through which the textile flat hose 12 is inserted. The second connection coupling 19 is disposed within the rhombus formed by the side plates 76. The four side plates 76 are mounted on the side arms 71 so as to be pivotable about a pivot axis 68. The side arms 71 can be folded out of the position shown in FIG. 13, so that the side plates 76 are pulled apart. In the stowed position 51, the side plates 76 are disposed closely adjacent to one another. In the operating position 52 shown in FIG. 14, the side plates 76 advantageously nearly form a square.

To wind up a textile flat hose 12, the hose is guided through the slot 78, so that the connection coupling 19 rests in the interior of the space that is delimited by the four side plates 76. The hose reel 65 is subsequently rotated about the axis of rotation 73. For this purpose, a control pin 74 is provided in the region of one of the hinges 77. The hose reel 65 is rotated in the direction of the arrow 75 about the axis of rotation 73 until the textile flat hose 12 is completely wound onto the hose reel 65. The side arms 71 are subsequently folded inwardly, and the hose reel 65 is pivoted about the pivot axis 68 into the receiver 70. In this state, the hose reel 65 can be disposed in the receptacle or holder 66 on the housing 2.

In the embodiment of a high-pressure cleaner 1 shown in FIGS. 15 and 16, a hose reel 85 is provided that in the stowed position 51 shown in FIG. 15 is disposed in a recess or receiving means 86 on the housing 2. The hose reel 85 is pivotable on a support or pivot shaft 90, about a pivot axis 88 on the housing 2, into the operating position 52 shown in FIG. 16. In this position, the pivot axis 89 of the hose reel 85 is disposed approximately parallel to the axes of rotation of the wheels 3 of the high-pressure cleaner 1. The hose reel 85 has two side plates 91, between which the textile flat hose 12 is guided. Provided on the outwardly disposed side plate 91 is a control pin 87, by means of which the hose reel 85 can be turned. As shown in FIG. 16, in the region of the recess or receiving means 86 the housing 2 is provided with a slot 92 through which projects the pivot shaft 90 in the stowed position 51 shown in FIG. 15.

The emptying or draining device shown in FIG. 17 is provided to ensure a complete draining of the textile flat hose 12 as it is being wound up. FIG. 17 shows a hose reel 95, which is rotatably mounted in a recess or receiving means 96 in the housing 2, only part of which is shown in FIG. 17. To turn the hose reel 95, a control pin 97 is provided on the outwardly projecting side plate 98 of the hose reel 95. The hose reel has a holder for the second connection coupling 19. The textile flat hose 12 is guided by the hose reel 95 between a housing wall 100 and a pressure or compression pin 99, between the two of which a slot 101 is formed through which a textile flat hose 12 extends. The dimension of the slot 101 is such that it is only slightly wider than the textile flat hose 12 in its flat, drained state. Thus, liquid that is still contained in the textile flat hose 12 can be squeezed or stripped out during winding-up of the textile flat hose 12.

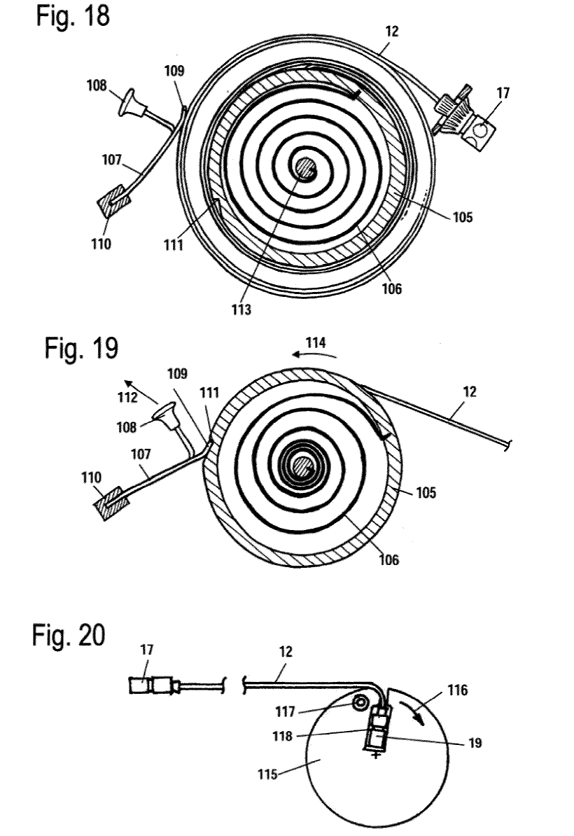

FIGS. 18 and 19 show an embodiment of an automatic winding device which is provided for a hose reel 105. Corresponding winding devices can be provided for the further illustrated embodiments of hose reels. The hose reel 105 has a return spring 106, one end of which is fixed to the hose reel 105 and the second end of which is fixed to a bolt 113 that is secured to the housing. When the textile flat hose 12 is unwound, the return spring 106 is tensioned. A spring 107 rests against an outer periphery of the textile flat hose 12 and is held in a mounting support 110 on the housing 2. The spring 107 has a detent 109 as well as a control knob 108.

FIG. 19 shows the hose reel 105 with the textile flat hose 12 completely unwound. Provided on the outer periphery of the hose reel 105 is a detent recess 111 into which, in the position shown in FIG. 19, the detent 109 is engaged. The return spring 106 is tensioned. To wind up the textile flat hose 12, the control knob 108 must be pulled out in the direction of the arrow 112, so that the detent 109 can pass out of the detent recess 111. Due to the force of the return spring 106, the hose reel 105 turns in the direction of the arrow 114, and the textile flat hose 12 is wound onto the hose reel 105.

In the embodiment of a hose reel 115 shown in FIG. 20, a holder 118 is provided for the second connection coupling 19. The holder 118 can be embodied in such a way that the second connection coupling 19 is always connected to the connector 5. A control pin 117 serves for turning the hose reel 115. To wind the textile flat hose 12 up, the hose reel 115 is turned in the direction of the arrow 116.

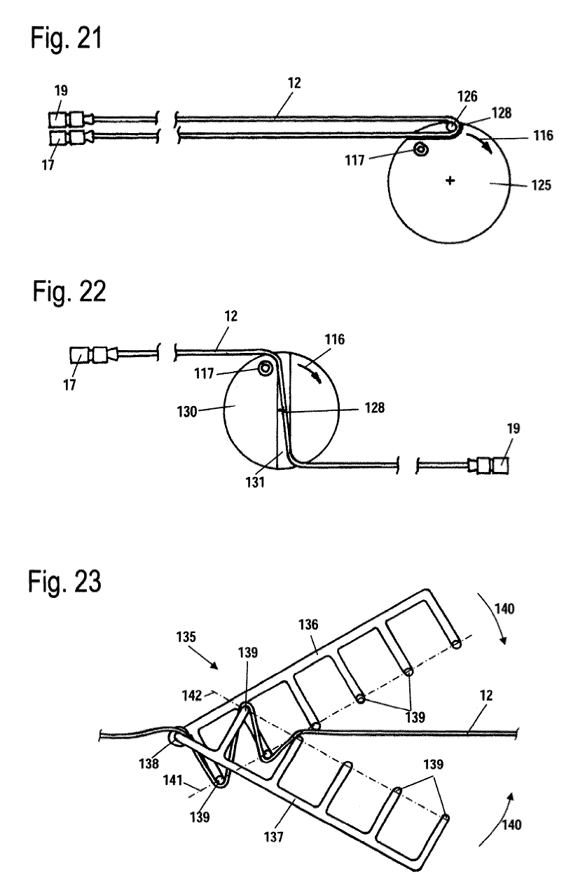

To enable a rapid winding and unwinding of the textile flat hose 12, the hose reel 125 shown in FIG. 21 is provided. The hose reel 125 has a support pin 126, on which the center 128 of the textile flat hose 12 can be suspended. To wind the textile flat hose 12, the hose reel 125 is turned in the direction of the arrow 116 at the control pin 117. In so doing, the textile flat hose 12 is wound onto the hose reel 125 in a double layer.

A double-layered winding is also possible with the hose reel 130 shown in FIG. 22. The hose reel 130 has a slot 131, which extends transverse to the hose reel 130 and through which the textile flat hose 12 is guided. In this connection, the center 128 of the hose is disposed approximately centrally in the slot 131. When the hose reel 130 is turned in the direction of the arrow 116, both ends of the textile flat hose 12 are wound up at the same time.

Instead of a winding device, a folding device can also be provided for the textile flat hose 12. One embodiment of a folding device 135 is shown in FIG. 23. The folding device 135 has two rakes 136 and 137, which are provided with deflection stubs 139 that are offset relative to one another. The deflection stubs 139 are provided in a first row 141 on the first rake 136 and in a second row 142 on the second rake 137. When the rakes 136, 137 are moved in the direction of the arrows 140 about the pivot support 138, the deflection stubs 139 are guided in a comb-like manner into one another. As a result, the textile flat hose 12 is alternatingly deflected at the deflection stubs 139 of the two rakes 136, 137, and is thus folded. By means of the two rakes 136 and 137, a textile flat hose 12 can be folded in a simple manner.

A second folding device 145 is shown in FIG. 24. The folding device 145 is formed of a plurality of toggle or hinged links 146, the ends of which are respectively interconnected. The points of connection of the links 146 are respectively embodied as pivot supports 147. Further pivot supports 147 are provided in the region of the centers of the hinged links 146. The thus-formed scissors structure is provided with deflection stubs 148, which are respectively disposed on one end of a hinged link 146. By shortening the folding device 145 in the direction of the arrow 149, the deflection stubs 148 are pressed outwardly in the direction of the arrows 150. At the same time, the spacing in the direction of the arrow 149 between the deflection stubs 148 is reduced. In this connection, the deflection stubs 148 are disposed in two rows 151 and 152, which upon shortening of the folding device 145 move away from one another. As a result, the textile flat hose 12 can be folded in a simple and rapid manner.

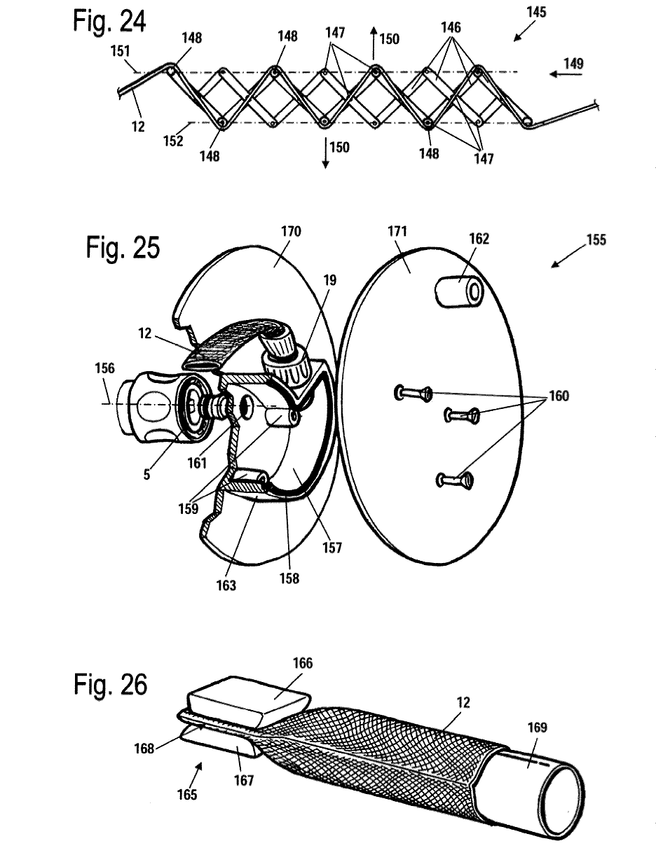

FIG. 25 shows an embodiment of a hose reel 155 in which the second connection coupling 19 is permanently connected with the connector 5. In this connection, the second connection coupling 19 is advantageously detachably disposed on the hose reel 155. The hose reel 155 has side plates 170 and 171, between which is provided a peripheral wall 163 on which the textile flat hose 12 can be wound. The hose reel 155 is rotatable about an axis of rotation 156. By means of an opening 161, the connector 5 is sealingly connected with an intermediate chamber 157 that is formed between the side plates 171 and 170. The intermediate chamber 157 is formed by the side plate 170, the peripheral wall 163 that is formed on the side plate 170, and the side plate 171. In this connection, the side plate 171 is disposed on a seal 158 on the peripheral wall 163, and is secured via fastening screws 160 to bosses 159 on the side plate 170. The second connection coupling 119 is sealingly connected to the interior of the intermediate chamber 157. As a result, despite the sealing connection between the connector 5 and the textile flat hose 12, the hose reel 155 is rotatable about the axis of rotation 156. A control pin 162 is provided for rotating the hose reel 155.

FIG. 26 shows an embodiment of an emptying or draining device 165. The device 165 includes two side members 166, 167, between which a slot 168 is formed. The textile flat hose 12 is guided through the slot 168. As a result, the textile flat hose 12 is squeezed, and any liquid that is still contained in the hose is pressed out.

The textile flat hose 12 shown in FIG. 26 has an inner structure 169, which is disposed within the woven fabric of the textile flat hose 12. The inner structure 169 is elastic, and can, for example, be a plastic hose, in particular one made of an elastomer or rubber. The inner structure 169 presses the woven fabric of the textile flat hose 12 open in the non-loaded, i.e. unwound or unrolled, state of the textile flat hose 12, in particular to form an approximately circular cross-section. In this way, the formation of kinks in the textile flat hose 12 is prevented. Due to the inner structure 169, the textile flat hose 12 can also withstand underpressures without collapsing. The purpose of the side members 166 and 167 of the draining device 165 is to press the textile flat hose 12 together with the inner structure 169 so that the textile flat hose 12 can be rolled up or folded up in a flat state.

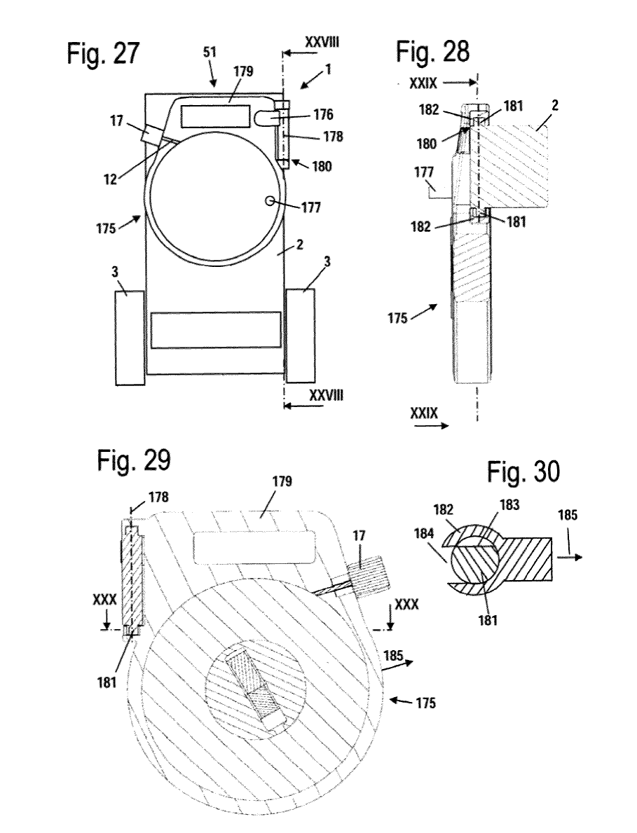

FIG. 27 shows an embodiment of a high-pressure cleaner 1 on which is held a hose reel 175. The hose reel 175 is held on the housing 2 of the high-pressure cleaner 1 so as to be pivotable about a pivot axis 178. In FIG. 27, the hose reel 175 is shown in the stowed position 51, in which it is pivoted against the housing 2. In this position, the hose reel 175 is held by a latch 176, which prevents pivoting of the hose reel 175. The hose reel 175 can be pivoted outwardly about the pivot axis 178 from the position shown in FIG. 27. For this purpose, the hose reel 175 is held by a pivot support 180. To turn the hose reel 175, especially for winding the textile flat hose 12 up, a control pin 177 is provided on the hose reel 175.

FIG. 28 shows a cross-section through the pivot support 180 with the hose reel 175 pivoted outwardly out of the stowed position 51. As shown in FIG. 28, the pivot support 180 is formed by two pins 181 that are formed on the housing 2 and that extend into two recesses 182 on the hose reel 175.

The hose reel 175 can be removed from the housing 2 of the high-pressure cleaner 1. For this purpose the latch 176 must be released, and the hose reel 175 must be pivoted outwardly about the pivot axis 178. As shown in FIG. 30, the lower pin 181 has a flattened area 183. Provided on the recess 182 is an opening 184, the width of which is less than the diameter of the pin 181. The width of the opening 184 corresponds to the width of the pin 181 in the region of the flattened area 183. As a result, in the outwardly pivoted position of the hose reel 175 shown in FIG. 30, the hose reel 175 can be pivoted outwardly in the direction of the arrow 185. In so doing, the lower pin 181 passes through the opening 184 of the recess 182. The hose reel 175 can subsequently be removed upwardly from the housing 2, whereby the upper recess 182 is removed from the upper pin 181. As a result, the hose reel 175 can easily be removed from the housing 2 of the high-pressure cleaner 1. In all other positions, the hose reel 175 is reliably held on the high-pressure cleaner 1, since in other positions the pin 181 cannot pass through the opening 184.

However, other configurations can also be provided that allow the hose reel to be removed from the housing 2. In this connection, it is in particular provided that the hose reel can be removed from the housing 2 only in a prescribed position, in particular one where it is pivoted outwardly, thus preventing an unintentional removal of the hose reel 175. Instead of the latch 176, further or other securing means can be provided for the hose reel 175.

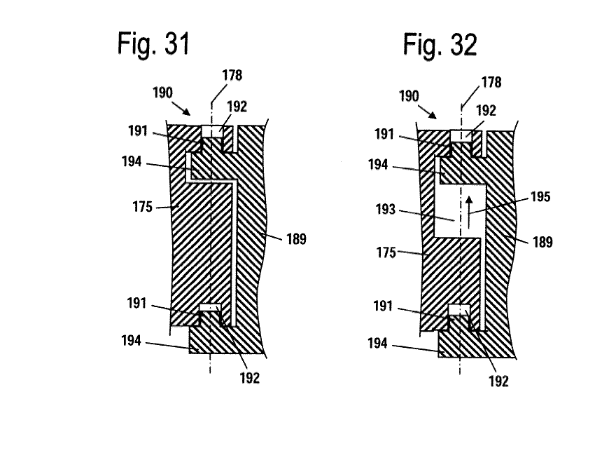

FIGS. 31 and 32 show an embodiment of a pivot support 190 for the hose reel 175. The pivot support 190 is formed by two pins 191, which extend into recesses 192 on the hose reel 195. The pins 191 are formed on laterally projecting arms 194 of the holder 189. The holder 189 is a separate component, which can be secured to the housing 2 of the high-pressure cleaner 1. Both of the pins 191 extend from below into the recesses 192. In the direction of the pivot axis 178, the hose reel 175 rests upon the arms 194. Since the hose reel 175 extends to below the upper arm 194, it is not possible for the hose reel 175 to move in the longitudinal direction of the pivot axis 178.

FIG. 32 shows the pivot support 190 in a different direction of rotation. In this position, a cutout 193 is disposed below the upper arm 194. The dimension of the cutout 193 in the longitudinal direction of the pivot axis 178 corresponds at least to the height of the pin 191. As a result, the hose reel 175 can be pulled upwardly in the longitudinal direction of the pivot axis 178, as indicated by the arrow 195. Thus, the recesses 192 can be raised off of the pins 191 and the hose reel 175 can be removed from the side.

Removal of the hose reel 175 in the position shown in FIG. 31 is not possible, since the hose reel 175 extends to just below the upper arm 194. Instead of such a configuration, an additional latch or the like can also be provided on the holder 189 or also on the housing 2 that in the pivot position shown in FIG. 32 releases the hose reel 175.

The specification incorporates by reference the disclosure of German priority document 10 2008 022 047.7 filed May 3, 2008.

The present invention is, of course, in no way restricted to the specific disclosure of the specification and drawings, but also encompasses any modifications within the scope of the appended claims.

We claim:

1. A high-pressure cleaner, comprising:
a housing;
a high-pressure hose carried by said housing and adapted to be connected to a spray fixture; and
a textile flat hose adapted to be carried by said housing, wherein said textile flat hose is further adapted to be connected to a water supply.

2. A high-pressure cleaner according to claim 1, further comprising a stowing device for said textile flat hose.

3. A high-pressure cleaner according to claim 2, wherein said stowing device is integrated into said housing.

4. A high-pressure cleaner according to claim 3, wherein said stowing device is adjustable on said housing between a stowed position and an operating position, and wherein in said operating position said textile flat hose can be removed from or disposed on said stowing device.

5. A high-pressure cleaner according to claim 4, wherein said housing is provided with a receiving means, and wherein in said stowed position said stowing device is disposed in said receiving means.

6. A high-pressure cleaner according to claim 2, wherein said stowing device includes a winding device for said textile flat hose.

7. A high-pressure cleaner according to claim 6, wherein said winding device includes a hose reel for said textile flat hose.

8. A high-pressure cleaner according to claim 7, wherein said hose reel is adjustable between a winding state and a stowed state, and wherein in said stowed state, a width of said hose reel, measured perpendicular to an axis of rotation of said hose reel, is less than a height of said hose reel, measured perpendicular to said axis of rotation.

9. A high-pressure cleaner according to claim 6, wherein said high-pressure hose and said textile flat hose are each adapted to be wound onto a respective hose reel, and wherein both of said hose reels are rotatable about a common axis of rotation.

10. A high-pressure cleaner according to claim 7, wherein said hose reel is provided with operating means for rotating said hose reel.

11. A high-pressure cleaner according to claim 6, wherein said winding device is provided with a support for a central portion of said textile flat hose.

12. A high-pressure cleaner according to claim 6, which includes an automatic winding device for said textile flat hose.

13. A high-pressure cleaner according to claim 12, wherein said winding device includes a return spring that is adapted to be tensioned during an unwinding of said textile flat hose.

14. A high-pressure cleaner according to claim 2, wherein said stowing device includes at least one holder secured to said housing, and wherein said textile flat hose is adapted to be wound about said holder.

15. A high-pressure cleaner according to claim 2, wherein said stowing device includes a folding device for said textile flat hose.

16. A high-pressure cleaner according to claim 15, wherein said folding device for said textile flat hose includes at least two rows of deflection stubs that are offset relative to one another, and wherein a spacing between said rows of said deflection stubs is variable.

17. A high-pressure cleaner according to claim 15, wherein said folding device for said textile flat hose includes two components that are adapted to engage into one another in a comb-like manner, and wherein said textile flat hose is adapted to be folded between said components.

18. A high-pressure cleaner according to claim 2, further comprising a connector for said textile flat hose, wherein said textile flat hose, which is disposed in said stowing device, is adapted to be connected to said connector.

19. A high-pressure cleaner according to claim 1, further comprising an emptying or draining device for said textile flat hose, wherein said emptying or draining device is adapted to squeeze or strip any residual liquid contained in said textile flat hose at least partially out of said hose during winding of said hose.

20. A high-pressure cleaner according to claim 19, wherein said emptying or draining device is provided with a slot through which said textile flat hose is guided.

21. A high-pressure cleaner according to claim 1, wherein said textile flat hose is provided with an inner structure that is adapted to press said textile flat hose open.
